(19) United States
(12) Patent Application Publication
(10) Pub. No.: US 2026/0347964 A1
(43) Pub. Date: Nov. 5, 2026

(54) APPARATUS AND METHOD FOR SHREDDING AND RECYCLING ELECTRONIC DEVICES CONTAINING LITHIUM BATTERIES

(71) Applicant: Gloyd Intellectual-Property Solutions, LLC, Houston, TX (US)

(72) Inventors: Jeffrey David Gloyd, Houston, TX (US); Andrew James Spencer, Rutland, VT (US); Patrick Michael Curran, Laguna Niguel, CA (US)

(73) Assignee: Gloyd Intellectual-Property Solutions, LLC, Houston, TX (US)

(21) Appl. No.: 19/739,286

(22) Filed: Jul. 13, 2026

Related U.S. Application Data
(63) Continuation-in-part of application No. 19/554,210, filed on Mar. 2, 2026.
(60) Provisional application No. 63/766,243, filed on Mar. 3, 2025.

(51) Int. Cl. C22B 1/248; H01M 10/54

(52) U.S. Cl. CPC C22B 1/248; H01M 10/54

(57) ABSTRACT

An apparatus and method for shredding and recycling electronic devices containing lithium batteries is disclosed. The system uses a deluge shredder to comminute the electronic devices while suppressing thermal events. Shredded material is separated into black mass slurry and solid fragments using a vibratory pan, with black mass recovered using a filter press. Solid fragments undergo density-based separation in a sink-float tank to recover plastics and metals. An integrated emissions treatment system captures and scrubs vapors and particulates, maintaining a closed-loop process. The fluid that is recovered from the black mass slurry is treated and recirculated for use in the deluge shredder and the emissions treatment system. The invention enables safe, efficient recycling of battery-containing electronic devices without prior battery removal.

### CROSS-REFERENCE TO RELATED APPLICATIONS

This application is a continuation-in-part of U.S. Pat. App. No.19/554,210 filed on Mar. 2, 2026 which claims priority from U.S. Provisional Pat. App. No. 63/766,243 filed on Mar. 3, 2025, both of which are hereby incorporated by reference herein.

### STATEMENT REGARDING FEDERALLY SPONSORED RESEARCH

Not Applicable.

### APPENDIX

Not Applicable.

### BACKGROUND OF THE INVENTION

### FIELD OF THE INVENTION

The present invention relates generally to systems and methods for mechanically processing electronic waste materials, and more particularly to systems and methods for safely shredding and separating electronic devices containing embedded lithium-ion batteries to recycle black mass material, ferrous metals, non-ferrous metals, and plastics.

### RELATED ART

Electronic waste (“e-scrap”) streams increasingly contain products with embedded lithium-ion batteries. Examples include laptops, tablets, mobile phones, cordless power tools, wireless speakers, robotic devices, and wearable electronics. These batteries are often inaccessible without extensive manual disassembly. Conventional recycling workflows rely on the labor-intensive removal of batteries prior to shredding due to the fire and emissions hazards associated with mechanical breakage of lithium-ion cells. When processed through traditional dry shredding systems, lithium-ion batteries can enter thermal runaway as a result of mechanical puncture, compression, or shear forces. Thermal runaway may initiate combustion, generate toxic fumes, and cause extensive facility damage or operator injury. Even small consumer cells can produce significant flame ejection and release highly reactive electrolyte vapors when compromised.

Existing mitigation systems for traditional dry shredding systems typically involve firefighting suppression equipment external to the shredder or environmental containment measures that react to, rather than prevent, hazardous conditions. None address the root problem: the inherent danger of combining batteries and dry shredding without a controlled quenching environment. Some prior art references propose discharging lithium batteries in a saline solution prior to shredding, such as US Pat. No. 12,334,522, while other prior art references propose immersing the batteries during the shredding process, such as US Pat. No. 11,273,453. More recently, the use of wet shredders have been incorporated into these systems, such as disclosed in US Pat. App. Pub. Nos. 2025/0038290 and 2025/0253425. However, these systems are designed for large-scale shredding and recycling operations which are particularly useful for electric vehicle lithium batteries and are not scaled for shredding and recycling of electronic devices that contain lithium batteries. Many recycling facilities receive mixed waste streams with electronic devices whose batteries cannot be easily removed prior to shredding, and these facilities require a system that allows for safe, economical shredding and recycling of the component in this e-scrap.

What is needed is an integrated mechanical and fluid-management system for shredding and recycling electronic devices that contain lithium batteries which eliminates the significant labor costs and safety risks associated with manual battery extraction. In particular, the waste management and recycling industry needs a scalable solution to safely and efficiently process electronic waste with devices that have embedded-batteries. Rather than constructing entirely new facilities for the electronic waste, it would be more efficient to use a turnkey system that is preassembled and can be transported in standard shipping containers so that they arrive in a condition that can be readied for operation without any additional construction required.

### SUMMARY OF THE INVENTION

An apparatus for shredding and recycling electronic devices containing lithium batteries includes a deluge shredder assembly, a vibratory pan assembly, a black mass tank, a filter press, a sink-float tank, an upper dewatering auger assembly, and a lower dewater auger assembly. The deluge shredder assembly receives the electronic devices and comminutes the electronic devices with a flow of water into solid fragments and a black mass slurry with black mass material mixed with the water. The vibratory pan assembly is positioned below the deluge shredder assembly and receives the solid fragments and the black mass slurry; the vibratory pan assembly includes a perforated plate and a ledge at a distal end. The slurry is pumped over to a round vibrating screen that further removes solids (solids are vibrated into the sink-float tank) while the slurry is pumped into the black mass tank. A pump pushes the black mass material and water from the black mass tank into the filter press to separate the black mass material from the water. The sink-float tank is positioned adjacent to the vibratory pan assembly and receives the solid fragments that fall off the vibratory pan assembly’s ledge into the sink-float tank’s saltwater bath that has a specific gravity that allows lighter plastic pieces in the solid fragments to float at the waterline and heavier pieces in the solid fragments to sink to the sink-float tank’s bottom. Upper and lower augers within the sink-float tank move the floating pieces and sunken pieces to an upper dewatering auger and a lower dewatering auger, respectively.

In one aspect of the invention, the components of the apparatus are mounted on a platform with a shipping configuration in which most of the components are within the platform’s perimeter and are in the same location and state as in an operating configuration with several components being secured within the platform’s perimeter during the shipping configuration and moved to be adjacent to the platform for the operating configuration.

In another aspect of the invention, the apparatus for shredding and recycling electronic devices reconditions and recirculates the liquid that is in the slurry after it is extracted from the black mass material in the filter press. The liquid is returned to a water tank where it is circulated through a cavitation system and is pumped to the deluge shredder and the wet scrubber.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1A is a front perspective view of the apparatus components assembled on a platform;

FIG. 1B is a back perspective view of the apparatus components assembled on a platform with a cutaway view of the deluge shredder assembly;

FIG. 2 is a schematic view of the components in the apparatus and their operations;

FIG. 3 is a schematic view of the components in the apparatus and the flow of fluids through the various components;

FIG. 4 is a cutaway perspective view of the sink-float tank with an upper dewatering auger, a lower dewatering auger, and a circular vibrating screen;

FIGS. 5A and 5B are a perspective view and a side view of the infeed hopper, respectively, with a detail view of the door the infeed hopper;

FIGS. 6A and 6B are a perspective view and a side view of the vibratory pan assembly, respectively; and

FIGS. 7A and 7B are a perspectives view of a shipping container and a flatbed semi-trailer showing the apparatus components assembled on a platform within a cutaway view the shipping container and on top of the flatbed semi-trailer, respectively.

### DETAILED DESCRIPTION OF THE PREFERRED EMBODIMENTS

The following description of the preferred embodiment(s) is merely exemplary in nature and is in no way intended to limit the invention, its application, or uses.

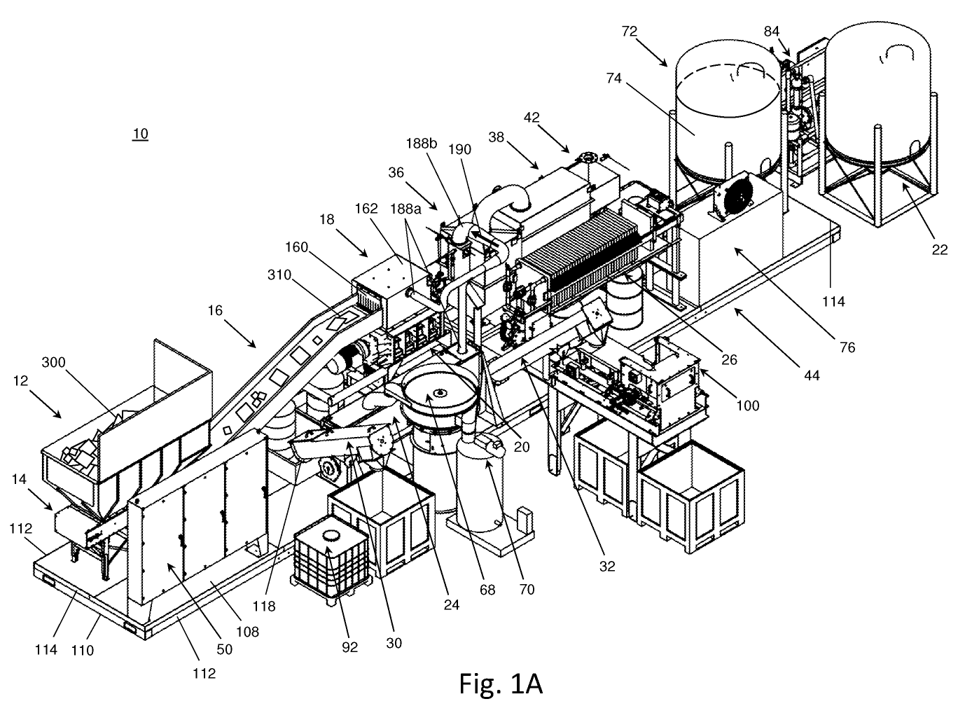

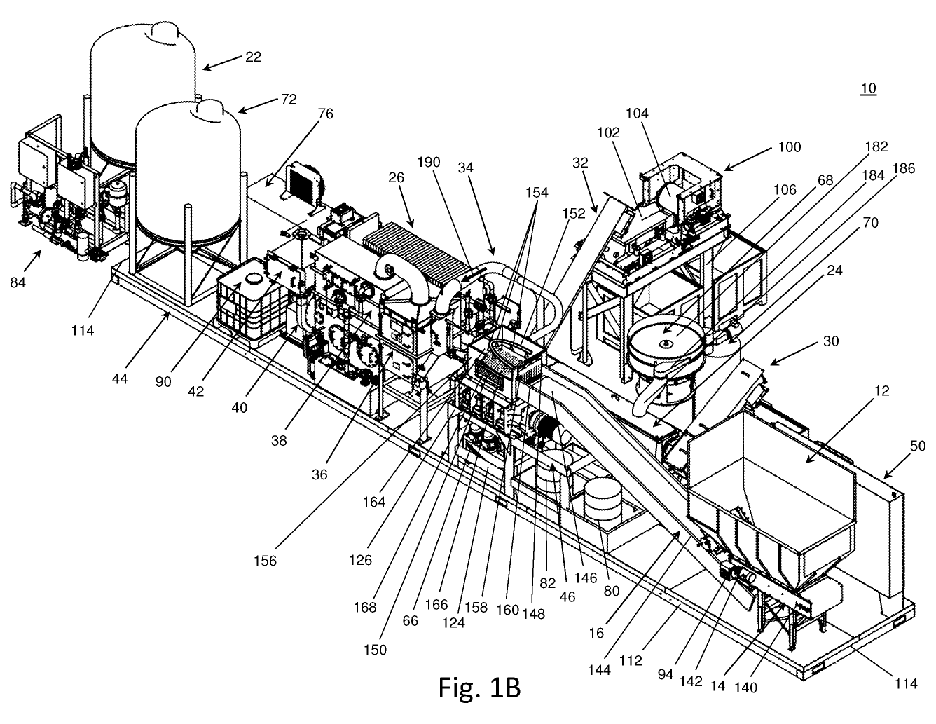

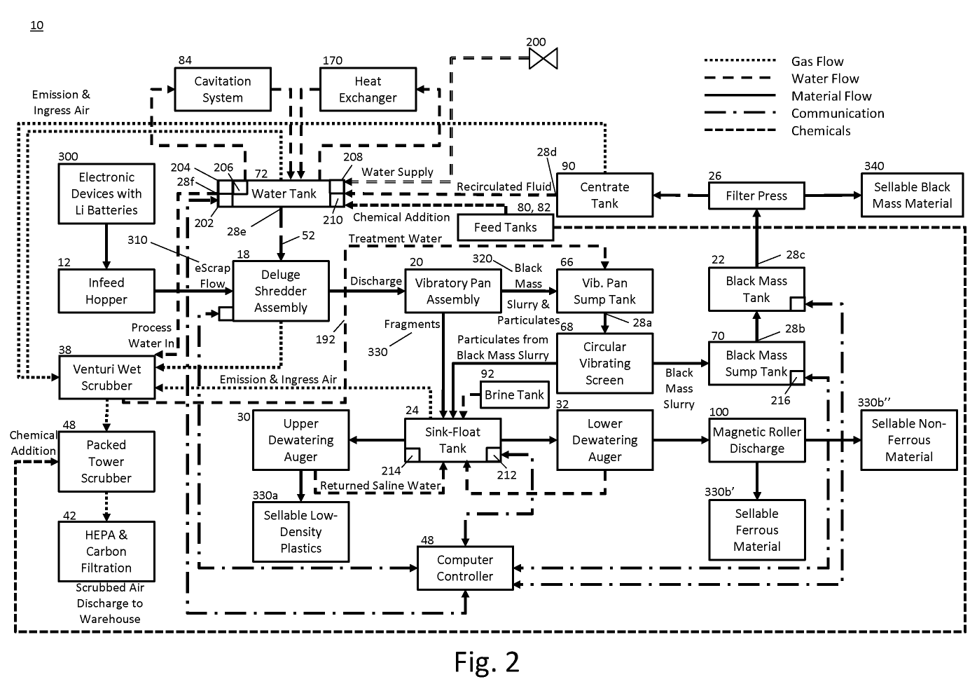

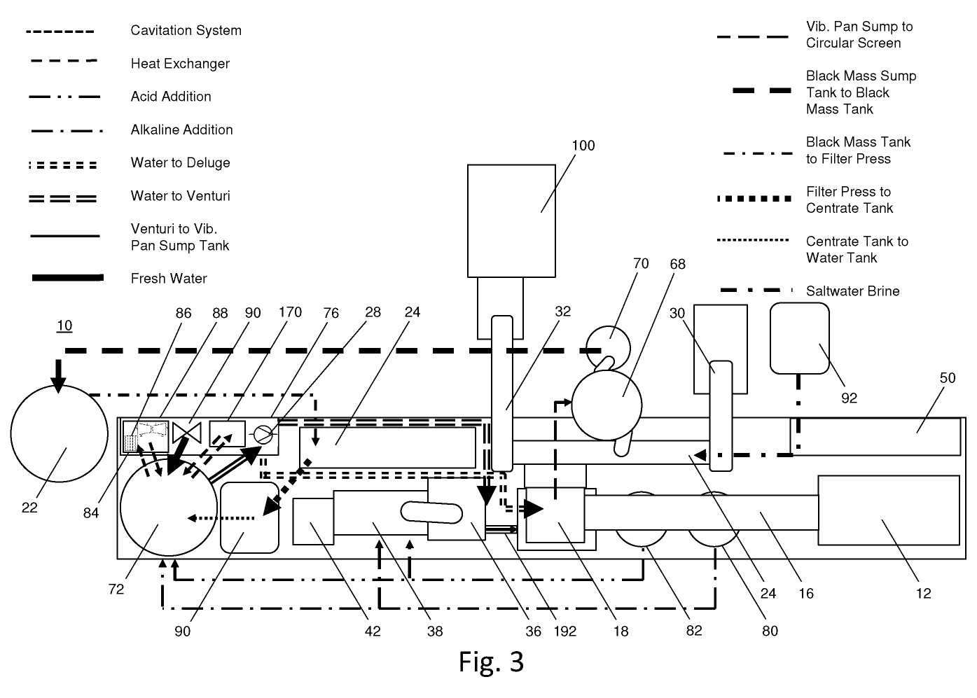

The present invention is an apparatus 10 and method for shredding and recycling a plurality of electronic devices containing lithium batteries 300 (e-scrap). The shredding and recycling apparatus is generally shown in FIGS. 1A and 1B, and a schematic view of the components in the apparatus and their operations are provided in FIGS. 2A and 2B. The apparatus has an infeed hopper 12 for the bulk loading of the e-scrap and which provides a regulated discharge of the e-scrap onto a lateral conveyor 14. The e-scrap is moved laterally under the infeed hopper and falls onto an inclined conveyor 16 which delivers the e-scrap into a deluge shredder assembly 18. Within the deluge shredder assembly, the e-scrap is continuously sprayed with a flow of water 52 to cool, suppress, and/or extinguish any thermal events produced by the lithium batteries as they are comminuted. The water flow preferably ranges between one (1) and fifty (50) gallons per minute to create a low-oxygen, high-moisture environment within the deluge shredder assembly. The deluge shredder assembly also preferably provides a sealed interface for the emissions system to maintain negative pressure.

A black mass slurry 320 and solid fragments 330 are discharged from the deluge shredder assembly and fall onto a vibratory pan assembly 20 with a perforated plate 54. The black mass slurry, including small particulates, passes through the perforated plate and, as described in detail below, are directed into a vibratory pan sump tank 66. The solid fragments remain on top of the perforated plate and are directed by shaking to the entrance of a sink-float tank 24. The black mass slurry with small particulates are pumped, preferably with a centrifugal pump 28a, from the vibratory pan sump tank to a circular vibrating screen assembly 68 where the small particulates contained in the black mass slurry are screened from the slurry and are discharged into the sink-float tank. The slurry passes through the perforations in the screen and collects in a black mass sump tank 70 where it is pumped into a black mass tank 22, preferably with another centrifugal pump 28b. The screened black mass slurry in the black mass tank 22 is forced into a filter press 26 by a pump, preferably a diaphragm pump 28c, to separate the black mass from the liquid in the slurry. The liquid removed from the black mass material 340 in the filter press is a mixture of water with dissolved chemical compounds which collects in a centrate tank 90 and is then pumped into a water tank 72, preferably by another centrifugal pump 28d. The water tank provides a reservoir of water 74 that is recirculated through the system, with another centrifugal pump 28e directing water back to the deluge shredder assembly and another pump 28f directing water to the emissions treatment system. As described in detail below, temperature, level, and flow are monitored to maintain operational safety and stability.

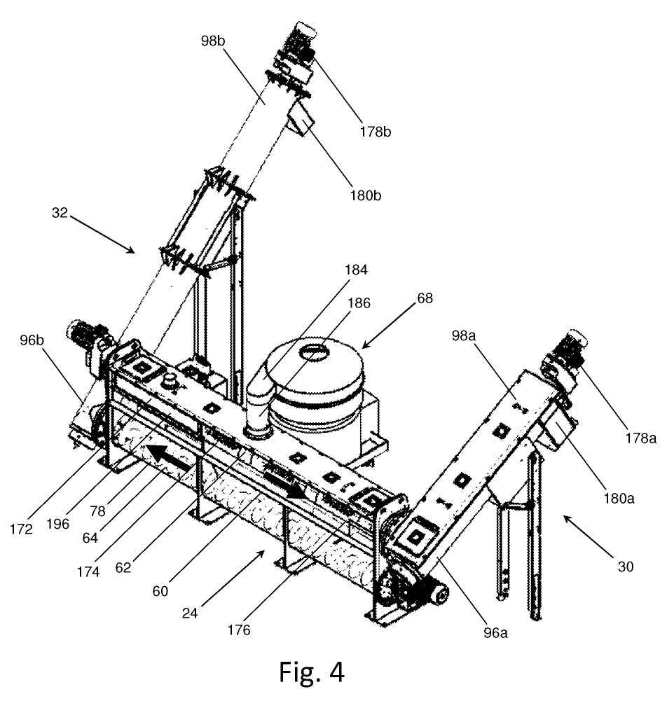

As shown in FIG. 1A, the sink-float tank 24 is positioned adjacent to the vibratory pan assembly 20 and is filled with a saltwater bath that is maintained at a controlled specific gravity, preferably between 1.08 and 1.22. Details of the sink float tank with the upper dewatering auger 30, the lower dewatering auger 32, and the circular vibrating screen assembly 68 are shown in FIG. 4. For the solid fragments, the sink-float tank 24 provides density-based separation of lighter plastic materials and heavier materials. In particular, the sink-float tank contains a saltwater bath 60 with a controlled specific gravity to float the lighter plastic pieces 330a from the solid fragments and sink the heavier pieces 330b, such as metal fragments and circuit board fragments, from the solid fragments. An upper auger 62 pushes the floating plastic pieces at the waterline 176 over a wire brush weir to an upper dewatering auger assembly 30. A lower auger 64 drags the sunken heavier pieces along the tank bottom 78 to a lower dewatering auger assembly 32. As described in detail below, the upper dewatering auger deposits the lighter plastic pieces in a container and the lower dewatering auger preferably deposits the heavier pieces on a magnetic roller discharge assembly 100 for further separation.

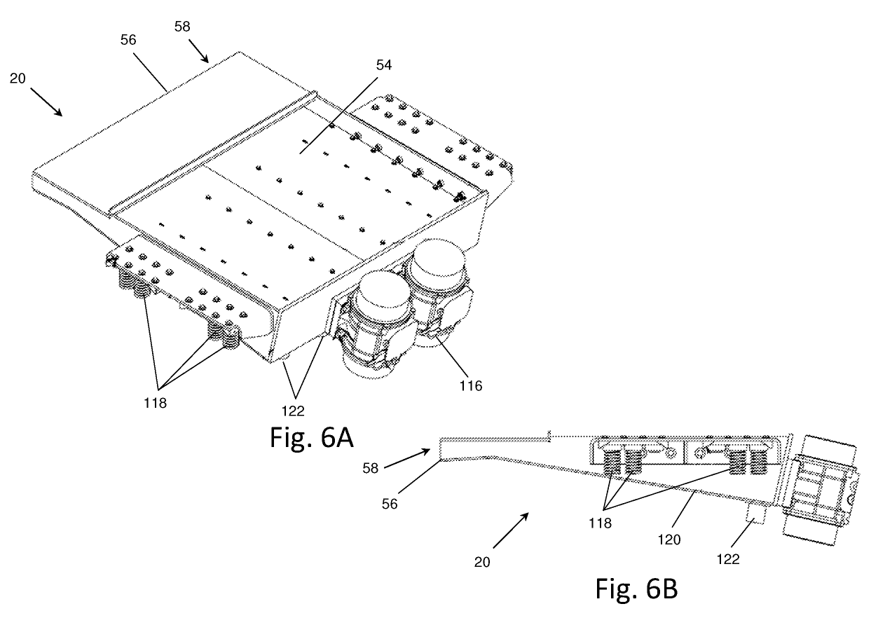

A ledge 56 at the distal end 58 of the vibratory pan assembly 20 (shown in FIGS. 6A & 6B ) extends into an interior 196 of the sink-float tank through a slot 172 in the sidewall 174 of the sink-float tank where the solid fragments drop into the saltwater solution. The sink-float tank is preferably constructed from stainless steel and has an approximate capacity of 225 gallons. The upper dewatering auger assembly 30 allows residual water from the plastic pieces to drain down to its lower end 96a which is at the waterline level of the water in the sink-float tank. The dewatered plastics are discharged from the dewatering auger assembly’s upper end 98a for further processing or disposal. The lower dewatering auger assembly 32 similarly allows residual water to fall back to its lower end 96b that contains saltwater from the sink-float tank while the dewatered pieces are deposited from its upper end 98b on the magnetic roller discharge assembly.

Emissions generated in the deluge shredder assembly, the water tank, and the sink-float tank are routed through exhaust ducts 34 to an emissions treatment system that includes a wet scrubber 36, a packed tower scrubber 38, a fan assembly 40, and a final high-efficiency particulate air (HEPA) filter and activated carbon filter 42. The system also uses closed-loop liquid recirculation to minimize the amount of water needed for the operations. Emissions first enter the wet scrubber. Water is injected to mix with the emission stream which removes the smoke (solid) particulates. The solids and liquid are heavy and fall down into a collection basin that is connected to the vibratory pan sump tank. The air emissions next pass through the packed tower scrubber to remove gas impurities. Small plastic media is ‘packed’ inside the equipment. Emissions are pulled through two internal chambers while a continual closed loop water system is pumped through the packed tower scrubber. Acidic compositions, toxic gases, and volatile organic compounds are pulled down and absorbed into the water while the cleaned emissions are pulled through to the blower. The blower creates the vacuum in the emissions system and pulls an average 1000 scfm of air. The emissions are then pushed through the HEPA and activated carbon filters to further remove any particulate matter remaining in the emission stream before releasing it into the warehouse.

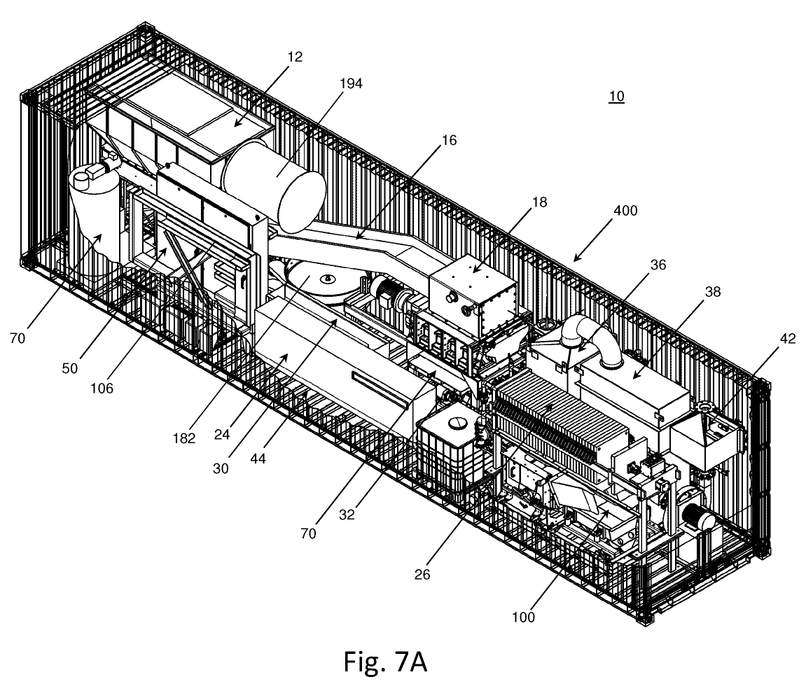

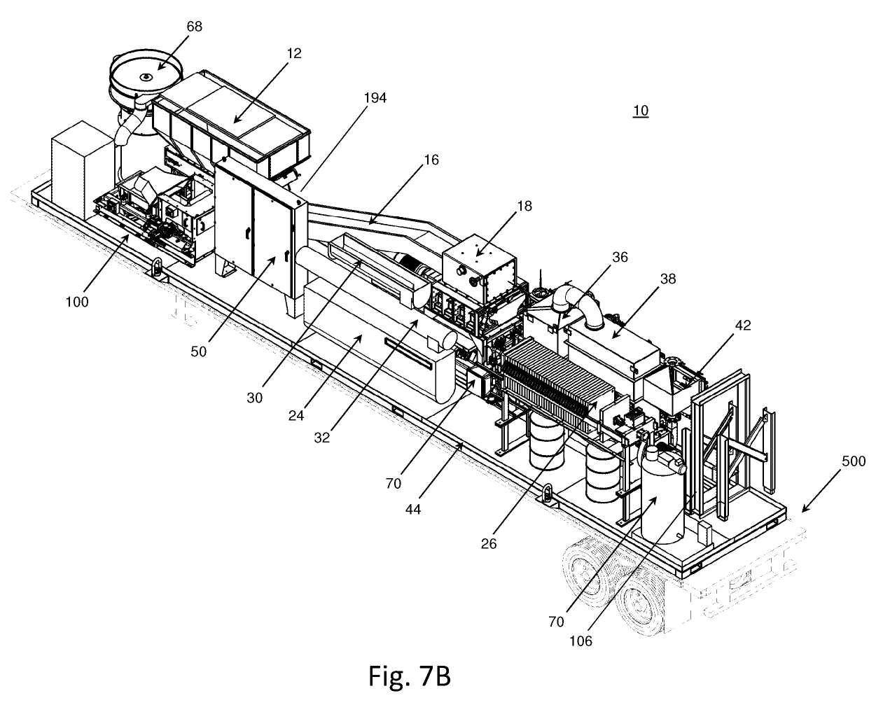

The entire apparatus is preferably mounted on an elongated platform 44 that can be transported in standard shipping containers 400 or on flatbed semi-trailers 500 so that it arrives in a condition that can be readied for operation without requiring any additional construction, preferably only changing the arrangement of several components in the apparatus and connecting them to the components that are fixed to the platform to transition from a shipping configuration such as shown in FIGS. 7A and 7B to an operating configuration such as shown in FIGS. 1A and 1B. As described in detail below, a shaker table frame 46 is mounted to the platform on opposite sides of the vibratory pan sump tank, and the deluge shredder assembly and the vibratory pan assembly are mounted to the shaker table frame’s top section. A computer controller 48 is preferably included in an electrical cabinet 50 to help automate the apparatus’ operation and to also provide warnings and to shutdown the system when components in the system that are being monitored operate outside their acceptable threshold ranges.

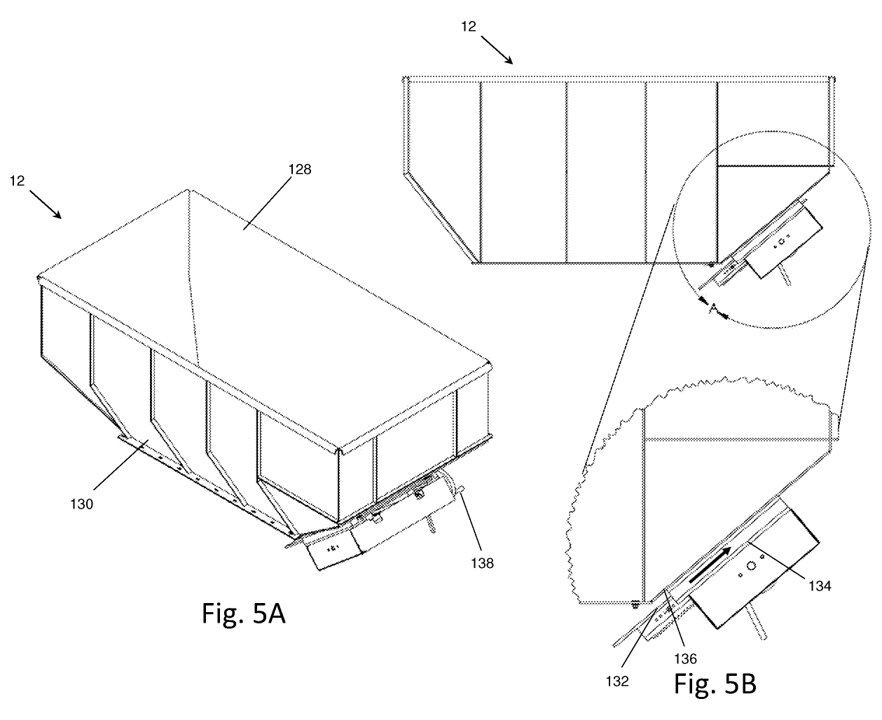

The infeed hopper that receives the electronic devices is preferably constructed from a structural steel, such as A36 carbon steel, and provides an approximate volumetric capacity of 94 cubic feet. This capacity is sufficient to supply thirty (30) to sixty (60) minutes of continuous shredder feed depending on the type of e-scrap material and the feed rate settings. As particularly shown in FIGS. 5A and 5B, the infeed hopper includes a tapered geometry consisting of a larger open topside 128 with a tapered lower section 130 that transitions into a discharge aperture 134 proximate to the bottom panel 136 of the tapered lower section. The upper section preferably measures approximately 42 ¾ inches in height, 50 inches in width, and 98 ½ inches in length. The tapered design promotes a consistent flow 310 of e-scrap and reduces bridging of bulky or irregularly shaped devices. A manually adjustable material flow door 132 is mounted at the lower discharge aperture. The door is moved using a hand-crank actuator 138 that allows operators to adjust the feed aperture to control the mass flow rate of e-scrap entering the lateral conveyor. In a restricted position, the door leaves open a smaller portion for a slower e-scrap flow rate, and in a fully open position, the opens the entire aperture for a faster e-scrap flow rate. This manual adjustment provides a simple and reliable means to regulate loading without the need for complex automated feed controls. It will also be appreciated that the door could be operated with actuators and controllers.

In operation, the e-scrap is dumped into the infeed hopper either by hand, forklift, or small front-loader, depending on the facility workflow. Once loaded, the e-scrap is drawn downward by gravity toward the controlled discharge door, where it is metered onto the moving belt of the lateral conveyor. The lateral conveyor’s base is mounted directly to the elongated platform, and the infeed hopper assembly is preferably bolted directly onto a reinforced section of the conveyor’s frame. Structural members and angled support brackets ensure that the infeed hopper’s weight and dynamic loading are transferred uniformly to the conveyor base. This integrated mounting design improves system rigidity and alignment between the infeed hopper’s outlet and the lateral conveyor’s tail which receives the e-scrap from the infeed hopper.

The lateral tail 140 of the lateral conveyor’s belt transports the e-scrap laterally to the lateral head 142 which is positioned above the inclined conveyor’s lower tail. The lateral conveyor preferably uses a crescent-top PVC belt designed to improve material stability and reduce rollback during surges. The lateral conveyor is preferably powered by a single electric motor 94a that is controlled using a variable frequency drive (VFD) which allows belt speed adjustments from low-feed maintenance mode up to nearly twelve (12) feet per minute. The lateral conveyor provides a continuous and regulated feed of e-scrap to the inclined conveyor, and the adjustable VFD enables operators to match the feed rate to downstream conditions, preventing overloading of the deluge shredder assembly. The frame for the lateral conveyor is preferably constructed from welded steel components, including four adjustable-height legs that are bolted directly to the platform for vibration control and machine alignment. The dimensions for the lateral conveyor are approximately 43 inches tall, 27 inches wide, and 71 inches long. The frame preferably includes angled steel mounting plates specifically designed to align and secure the infeed hopper to ensure that the e-scrap exiting the infeed hopper falls directly onto the moving belt without spillage.

At the head of the lateral conveyor, the e-scrap falls onto the lower tail 144 of the inclined conveyor where it is transported to the upper head 146. The inclined conveyor elevates the e-scrap from the lateral conveyor into the deluge shredder assembly. The inclined conveyor has an incline of approximately thirty (30) degrees above horizontal to provide the necessary lift. The inclined conveyor uses a crescent-top PVC belt similar to the lateral conveyor but operates at a higher maximum speed of approximately nearly sixty (60) feet per minute. The one (1) HP motor 94b, operating at 1800 rpm and reduced through a 30:1 gearbox, provides the necessary torque, and the belt speed is controlled using a dedicated VFD. The inclined conveyor’s frame is preferably fabricated from structural steel and includes four adjustable support legs with bolt-down plates. The physical dimensions of the conveyor frame are approximately 83 ½ inches tall, 20 inches wide, and a little over 142 inches long. A nose-over section at the upper head’s discharge end ensures that material entering the deluge shredder assembly falls vertically downward into the shredder entry zone, preventing material from skipping or bouncing out of the shredder’s hopper and enhancing safety by ensuring all feedstock passes through the deluge zone.

The deluge shredder assembly has a deluge hopper 148, a wet shredder 150, a spray bar 152, and multiple nozzles 154. The deluge hopper is preferably made from structural steel and is fastened through a mounting flange directly to the top of the wet shredder with bolts and an EPDM gasket. The deluge hopper has a closed top 162, an open bottom 164 to the wet shredder’s cutting chamber 166, an opening 158 in one of its sidewalls 156, and an EPDM rubber curtain 160 with vertical slits is installed at the opening where the e-scrap from the inclined conveyor is deposited. The curtain reduces water splash-out and air ingress and aids in the maintenance of negative pressure inside the deluge shredder assembly. In general, the deluge shredder assembly performs three essential functions: (1) it provides a singular entry point for all incoming e-scrap materials; (2) it establishes a controlled deluge environment to quench thermal events while the e-scrap is comminuted; and (3) it forms the sealed interface through which emissions are extracted to the system’s scrubbers.

The spray bar 152 is positioned proximate to the deluge hopper’s closed top 162. The nozzles are fluidly connected to the spray bar and are aimed downward toward the open bottom 164 of the deluge hopper 148. The spray bar is preferably a two (2) inch stainless steel spray weldment which feeds six (6) spiral-pattern spray nozzles arranged to fully cover the cutting chamber. As indicated above, the spray system can deliver between one (1) and fifty (50) gallons per minute of water which can be varied based on operational conditions and fire suppression requirements. The nozzles spray the continuous flow of water onto the e-scrap upon entering the deluge hopper through the opening and while the electronic devices fall through the open bottom in the deluge hopper and are comminuted in the cutting chamber into the solid fragments and the black mass slurry which includes water, fine battery materials, graphite, electrolyte residue, and various micron-scale particulates. A four (4) inch diameter side-mounted exhaust duct 34 is connected at its upstream end 188a to one of the deluge hopper’s sidewalls to allow the deluge hopper to interface with the emissions treatment system, enabling continuous extraction of vapors, smoke, and aerosolized particulates via the negative pressure.

During operation, all e-scrap materials entering the deluge shredder assembly fall through the deluge zone in the deluge hopper below the nozzles, ensuring they are wetted before contacting the shredder shafts in the cutting chamber. This wetting significantly reduces the likelihood of ignition, flame propagation, or thermal runaway events from embedded lithium-ion cells. In the preferred embodiment, the cutting chamber has a four-shaft industrial shredder configured for wet operation, such as the Untha® QS-40 (Generation 2.0) shredder which is equipped with two (2) thirty (30) HP electric motors, each driving paired cutter shafts through a reduction gearbox. The primary cutter shafts operate at approximately twenty-nine (29) rpm, while the secondary cutter shafts operate at approximately thirty-eight (38) rpm. The cutters include cast-iron nineteen (19) mm two (2) tooth designs on the primary shafts and case-hardened steel nineteen (19) mm four (4) tooth elements on the secondary shafts. This arrangement promotes efficient shearing of plastics, ferrous and non-ferrous metals, and lithium-ion cell casings.

A sizing screen 168, such as a Hardox® steel sizing screen, is mounted beneath the cutting chamber 166. The screen includes openings which allows only the black mass slurry and solid fragments that have been sufficiently reduced in size to pass through onto the vibratory pan assembly below the deluge shredder assembly. The openings can be approximately fifteen (15) mm although it will be appreciated that other size openings could also be used for the screen. Oversized pieces remain in the cutting chamber while they are further comminuted. The deluge shredder assembly includes built-in overload protection and automatic reverse cycling in the event that particularly dense materials become lodged between the cutters. In addition to reducing the available oxygen in the deluge hopper and wet shredder, the water introduced in the deluge zone cascades across the cutters and the screen, cooling the cutting environment. The constant deluge extinguishes flames associated with lithium-ion battery ruptures and suppresses the emission of hazardous vapors.

Details of the vibratory pan assembly are described below with reference to FIGS. 6A and 6B. The perforated plate 54 in the vibratory pan assembly 20 is constructed from stainless steel and features a screening surface with small diameter perforations, such as 3/32-inch diameter perforations. Two (2) vibratory motors 116, such as Powtek VE3/18/1500 industrial vibrators, are mounted to the vibratory pan assembly and preferably operate in coordinated counter-rotation to provide linear vibration that drive the solid fragments across the perforated plate toward a distal edge of the vibratory pan assembly. Each motor is driven by a variable frequency drive (VFD), allowing operators to adjust vibratory amplitude and frequency for optimal material transport and liquid separation. The vibratory pan assembly is supported by twelve (12) stainless steel springs 118 arranged around its perimeter. These springs provide vibration isolation and maintain consistent oscillatory motion during operation.

The vibratory pan assembly 20 also includes a welded stainless steel collection tray 120 positioned beneath the perforated plate. The collection tray is slanted downward away from the distal edge, and several ports 122 are attached to the bottom of the collection tray at its lowest region. As the black mass slurry from the lithium-ion batteries and solid fragments fall onto the vibratory pan assembly, the black mass with water and small particulates pass downward through the perforated plate into the steel collection tray and continue down the slanted bottom surface to the ports. The ports are connected to the vibratory pan sump tank 66 through pipes which channel the black mass slurry and small particulates to the vibratory pan sump tank. The solid fragments that are not small enough to fit through the perforations remain on the top of the perforated plate and are conveyed forward by the vibratory motion toward the distal edge. The physical dimensions of the vibratory pan assembly are approximately 17 ¾ inches tall, 53 ¾ inches wide, and 63 ¾ inches long, enabling it to span the full width of the shredder discharge area.

The vibratory pan sump tank 66 is preferably a welded stainless steel vessel with a nominal capacity of approximately 45 gallons that is positioned directly beneath the vibratory pan assembly to receive the black mass slurry through the pipes connected to the vibratory pan assembly’s collection tray. The vibratory pan sump tank’s physical dimensions are 27 7/32 inches tall, 39 3/8 inches wide, and 53 inches long, allowing it to fit neatly within the footprint of the shaker table frame. The black mass slurry with particulates enters the vibratory pan sump tank through the ports located beneath the vibratory pan. The vibratory pan sump tank preferably incorporates a sloped bottom to encourage particulate settlement at its lowest end, and the pump 28a feeds the black mass slurry with particulates to the circular vibrating screen assembly.

The circular vibrating screen assembly 68 is preferably a welded stainless steel vessel with a 2.5HP off-set motor that causes the assembly to vibrate. The black mass slurry is pumped onto a fine mesh screen 182 at the top of the assembly which separates the particulates from the black mass slurry. The particulates are held on the top of the mesh screen and discharged through a side outlet 184 and tube 186 into the float-sink tank while the black mass slurry is collected in a black mass sump tank. The tank’s physical dimensions are 27 7/32 inches tall, 39 3/8 inches wide, and 53 inches long. The black mass slurry is pumped from the black mass sump tank to the black mass tank.

The black mass tank is preferably a large plastic tank that can be positioned off of the platform. The black mass tank preferably has a sloped bottom and in the preferred embodiment has a capacity of 1,000 gallons. The diaphragm pump 28c removes black mass slurry from the black mass tank and passes it through a 34-plate filter press equipped with 2–3 micron filtration media, such as the Met-Chem® MC-10-630-34 filter press. As solids accumulate, internal filter pressure increases from 30 psi up to approximately 90 psi. When 90 psi is reached, a signal is sent to the system’s computer controller to pause the lateral conveyor and the inclined conveyor until the filter press is serviced. As indicated above, the liquid from the filter press is collected in the centrate tank 90 and a separate centrifugal pump 28d preferably pumps the liquid to the water tank which supplies water to the deluge shredder assembly’s spray bar and to the wet scrubber in the emissions treatment system. Water used in the emissions treatment system drains back into the vibratory pan sump tank and then to the black mass tank, enabling closed-loop recirculation. It will be appreciated that other equipment could be used to separate the black mass material from the liquid in the black mass slurry. For example, a centrifuge filter or a hydrocyclone could be used in place of the filter press as a means for separating the black mass material from the water.

The water tank can be a large plastic tank with a capacity of 1,000 gallons and preferably includes instrumentation in communication with the computer controller for monitoring and controlling operations of the system: one (1) temperature sensor 202, one (1) continuous level sensor 204, two (2) discrete level switches 206, one (1) conductivity meter 208, and one (1) pH probe 210. When the temperature sensor reads a temperature in the water tank that reaches an elevated temperature threshold, such as 65°C, the computer controller provides a warning and starts routing the water through a heat exchanger 170 that is preferably housed in a pump cabinet 76 which is attached to the platform within its perimeter. If the temperature reaches a highly elevated temperature threshold, such as 85°C, the computer controller automatically shuts down the system. Level sensors initiate automatic makeup water flow through the valve 200 to the water main when volume drops below a minimum threshold of approximately 240 gallons and prevent overflow when volume exceeds a maximum threshold of approximately 950 gallons.

The computer controller preferably monitors the pH probe to maintain the liquid in the water tank within a range of 6 – 10 pH using additions of an acid solution, such as a sulfuric acid (H₂SO₄) solution 80, and an alkaline solution 82, such as a calcium hydroxide (Ca(OH)₂) solution, that are pumped from separate feed tanks which are preferably positioned below the inclined conveyor. A closed-loop cavitation system 84 is also included on a closed loop water circulation loop of the water tank. The cavitation system preferably includes an electrolysis cell 86 to improve the efficiency in breaking down complex organic chains into simple building blocks of C, H, and O compounds and helps to prevent electrode fouling, and may include dual hydrodynamic or acoustic cavitation cells 88. Although FIGS. 1A and 1B show the cavitation system as a separate unit that is positioned off of the platform, in the preferred embodiment, the cavitation system is integrated into the pump cabinet as shown in FIG. 2. Additionally, the water tank preferably includes an exhaust duct that is connected to the emissions treatment system to remove any gases that are generated by the cavitation system. The conductivity meter is preferably used to troubleshoot the quality of the water in the water tank which is being recirculated through the deluge shredder, the emissions system, and the filter press plate.

In the cavitation system 84, the dual cavitation cells 88 preferably have opposing cavitation nozzles. The inclusion of the electrolysis cell 86 in combination with the dual cavitation cells is particularly beneficial because it generates oxidants and eliminates the need for other cavitation enhancing reagents. Generally, the cavitation system destroys organics at or greater than the rate of their release into the water recirculation loop from the wet shredding process. Organics liberated during the wet shredding process include electrolytes such as polypropylene carbonate, adhesives, fluorinated polymers, binders, and other organic compounds. Circulating a portion of the water loop through the cavitation system also minimizes the growth of biologicals such as algae. The combination of the dual cavitation cells 88 and the electrolysis cell 86 results in a higher rate of destruction with lower energy demands than either cavitation or electrolysis alone. In operation, the water passes through the electrolysis cell and into the dual opposing cavitation nozzle manifold. The activated solution passes through a charged ceramic media which causes the dissolved solids to precipitate. The media filter is back washed periodically and the precipitate laden solution is filtered and solids removed and solution recycled back into the system.

Similar to the water tank, the sink-float tank also incorporates instrumentation in communication with the computer controller for monitoring and controlling operations of the system: one (1) continuous level sensor 212 and two (2) discrete level switches 214If the liquid levels exceed a maximum threshold of 225 gallons or drop below a minimum threshold of 185 gallons, the computer controller automatically shuts down the system. At the maximum level, the waterline remains below the bottom edge of the slot. The saltwater in the sink-float tank can be replenished with saltwater from the brine tank 92. The black mass tank may also include a level sensor, a high level switch and a low-level switch.

The dewatering auger assembly 30 shown in FIG. 4 is constructed of stainless steel with a dewatering chamber at the lower end and a long tubular housing extending upward to the discharge chute. The lighter plastics that are pushed over the crest of the brush weir are funneled down to the lower end of the inclined auger. A four (4) HP electric motor 178a drives the auger through a 16.53:1 reduction gearbox. The auger operates at adjustable speeds controlled via a VFD, with a maximum rotational speed of approximately 88 rpm. The dewatered lighter plastics are conveyed upward through the inclined tube and deposited through the discharge chute 180a into collection bins, gaylords, or downstream processing equipment. The dewatering auger assembly preferably includes adjustable support legs for direct mounting to the platform and a flanged connection to the sink-float tank. A four (4) HP electric motor 178b drives the auger through a 16.53:1 reduction gearbox. The auger operates at adjustable speeds controlled via a VFD, with a maximum rotational speed of approximately 88 rpm. The dewatered metals are conveyed upward through the inclined tube and deposited through the discharge chute 180b onto the magnetic roller discharge assembly. The dewatering auger assembly preferably includes adjustable support legs for direct mounting to the platform and a flanged connection to the sink-float tank.

The magnetic roller discharge assembly 100 includes a vibrating stainless steel tray 102, a magnetic drum roller 104, and a steel stand 106. The plate in the vibratory pan assembly is constructed from stainless steel, and two (2) vibratory motors, such as Powtek VE3/18/1500 industrial vibrators, are mounted to the vibratory pan assembly and preferably operate in coordinated counter-rotation to provide linear vibration that drive the solid fragments across the plate toward a distal edge of the vibratory pan assembly. The vibration of the solid fragments also spreads them out into a flat uniform layer. Each motor is driven by a variable frequency drive (VFD), allowing operators to adjust vibratory amplitude and frequency for optimal material transport. The vibratory pan assembly is supported by twelve (12) stainless steel springs arranged around its perimeter. These springs provide vibration isolation and maintain consistent oscillatory motion during operation. The magnetic drum roller spins around via a VFD controlled motor and separates ferrous material 330b’ from non-ferrous materials 330b”. The magnetic field is an adjustable 120° field. The non-magnetic material drops down a front chute and are collected in a container below. Magnetic particles stick to the rotating magnetic drum roller and drop off into a back chute when the material exits the 120° magnetic field. A fixed brush on the bottom of the magnetic drum roller helps brush any remaining material before the drum spins back into the magnetic pole again. These particles drop down on the back end and are collected in a container below.

The apparatus preferably includes a multistage emissions treatment assembly that is preferably designed to process up to approximately 1000 actual cubic feet per minute (acfm) of air extracted from the deluge shredder assembly 18 and the sink-float tank 24 through the exhaust ducts 34. The emissions system begins with the wet scrubber 36 at the downstream end 188b of the exhaust ducts. The wet scrubber is preferably a dual-throat scrubber which injects between four (4) and ten (10) gallons per minute of recirculated water supplied from the water tank into a high-velocity airflow 190 path to capture smoke, aerosolized battery electrolyte vapors, and fine particulate matter. Entrained solids and condensate drain downward and return to the vibratory pan sump tank through a drain tube 192.

Vapor exiting the wet scrubber flows into the packed tower scrubber 38 which includes two stages of polypropylene packing media. The first stage is approximately four (4) feet high and the second stage is approximately two and a half (2.5) feet high. A dedicated 1 ½ HP pump circulates water through the tower, achieving approximately 99% removal of particulates that are ten (10) microns or larger and significantly reducing acid gases and volatile organic compounds. The acid and alkaline solutions that are used to maintain the pH level for the liquid in the water tank are also preferably used to maintain the optimal pH level in the packed tower scrubber to neutralize pollutants while preventing corrosion and scaling.

Downstream of the scrubbers, the air stream is drawn through a 7.5 HP centrifugal exhaust fan 40. The fan maintains the negative pressure required for continuous emissions capture at the exhaust duct interfaces with the deluge shredder assembly and the sink-float tank. Airflow is regulated to ensure a maximum draw of approximately 1000 acfm. The final stage of the emissions system is the HEPA filter 42 which captures ultrafine particulates, including trace black mass dust, while the carbon filter removes residual VOCs and electrolyte vapors. All liquids and condensates from the scrubbers are routed back to the black mass tank, maintaining liquid recirculation within a closed-loop operation.

As generally described above, the entire apparatus is preferably mounted on the top surface 108 of the elongated platform 44 with longitudinal sides 112 and transverse sides 114 therebetween that are sized to be transported in standard shipping containers 400, such as shown in FIG. 7A, or on a flatbed semi-trailer 500, such as shown in FIG. 7B. The platform is fabricated as a rigid, welded steel frame with an overall length of approximately 467.5”, a width of approximately 91”, and a vertical height of 13”, measured from the platform’s bottom surface 110 to the top mounting surface 108. The platform preferably includes bolt-down mounting points for anchoring the system to a concrete foundation. Accordingly, the platform functions as both a structural base and a transportation skid, enabling the system’s components to be fully assembled off-site and transported as a single integrated unit. When assembled, the platform and attached apparatus are sized and arranged to slide into a standard 40-foot high-cube shipping container, enabling containerized transport by road, rail, or sea without partial disassembly. It will be appreciated that the platform can be slightly longer when it is being transported on a flatbed semi-trailer and does not need to fit within a shipping container.

The platform includes reinforced beams, cross-members, and localized load-bearing regions aligned with major equipment components of the system’s apparatus. Integrated lifting pockets and attachment points allow the platform to be lifted using forklifts, cranes, or container-handling equipment. Mounting features mechanically secure the components to the platform, reducing vibration, shifting, and mechanical stress during transport. In use, the platform remains in place during installation, allowing the system to be deployed rapidly by positioning the platform within a facility and connecting utilities, thereby reducing installation time and minimizing on-site mechanical assembly. The system preferably includes the electrical and computer control cabinet and the pump cabinet that are mounted to the platform for the shipping configuration which is also in a state that is ready for the operating configuration, being connected to the pieces of equipment that are also ready for the operating configuration when in the shipping configuration.

For the shipment of the apparatus, most of the components are positioned within the platform’s perimeter in the shipping configuration, i.e., within the longitudinal sides and the transverse sides. Many of these components in the shipping configuration are also ready for use in the operating configuration of the apparatus. When the apparatus is readied for operation and during its operations, several components are moved from their location on the platform in the shipping configuration into their location for use in the operating configuration for the apparatus. In the transition from the shipping configuration to the operating configuration, the components to be moved from their location in the shipping configuration either extend beyond the platform’s perimeter or are positioned adjacent to the platform at the facility. The largest tanks, such as the water tank and the black mass tank, are preferably not included with the equipment and other components on the platform in the shipping configuration and can either be shipped from their source directly to the facility or may initially be assembled with the other components prior to shipment for testing purposes and then separately shipped to the facility for reassembly. It will be appreciated that the initial assembly for testing purposes could be performed with testbed tanks and a testbed black mass tank so that the operational tanks can be shipped directly from their source.

The following components are connected to the elongated platform in the shipping configuration and are in an operational relationship with each other in the shipping configuration and remain connected to the elongated platform in the same location in the operating configuration of the apparatus: the infeed hopper assembly, the inclined conveyor, the shaker table, the deluge shredder assembly, the vibratory pan assembly, the vibratory pan sump tank, the sink-float tank, the filter press, the wet scrubber, the packed tower scrubber, the exhaust fan, the high-efficiency particulate air filter, the electrical cabinet, and the pump cabinet. As evident in FIGS. 1A, 1B, 7A, and 7B, each one of the dewatering auger assemblies has a stowed arrangement within the perimeter of the elongated platform for the shipping configuration of the apparatus and each also has an engaged arrangement for the operating configuration of the apparatus. In particular, their lower ends are disconnected from the sink-float tank in the stowed arrangement and connected to the sink-float tank in the engaged arrangement, and their upper ends extend beyond the perimeter in the engaged arrangement.

The particular arrangements of the components that are moved from the shipping configuration into the operating configuration can vary depending on the particular mode of shipment. For example, when transported within the shipping container, the dewatering auger assemblies are preferably secured between the sink-float tank and the shaker table, and when transported on the flatbed semi-trailer, they are preferably secured on top of the sink-float tank. As another example, when the circular vibrating screen is transported within the shipping container, the top section with the screen, the motor, the side outlet, and the tube can be separated from the base 194 while the entire unit can remain assembled on the flatbed semi-trailer.

Most of the system’s components are mounted directly to the elongated platform 44, but some components are mounted to the shaker table frame 46 to isolate vibratory loads and prevent unwanted oscillation transfer into adjacent components. The lateral conveyor 14, the sink-float tank 24, and the modules that form the emissions treatment assembly are mounted directly to the elongated platform separate from the shaker table. The bottom section 124 of the shaker table frame is mounted to the platform adjacent to the sink-float tank, and its top section 126 extends above and over the vibratory pan sump tank. The deluge shredder assembly 18 and the vibratory pan assembly 20 are mounted to the top section of the shaker table frame. For the inclined conveyor 16, its lower tail 144 is preferably mounted directly to the elongated platform 44 while its upper head 146 is mounted to the top section of the shaker table frame 126.

The shaker table frame is constructed from welded stainless steel tubing and plate sections, and its dimensions are approximately 46 5/16 inches tall, 48 ¼ inches wide, and 124 ½ inches long. Structural stiffness is maintained through cross-bracing integrated into the tubular parts. As indicated above, the shaker table frame’s open central portion is sized to accommodate the black mass tank. The upper section provides mounting rails for the vibratory pan and the shredder support structure, ensuring a consistent discharge trajectory from the shredder to the vibratory pan. The upper section includes mounting provisions for the inclined conveyor to ensure precise vertical alignment between the conveyor discharge nose and the deluge hopper’s opening.

The plumbing between the equipment mounted to the platform is performed prior to shipment of the system so that only the plumbing to the equipment that is off of the platform is required for final installation of the system. The plumbing safely manages process water, saline separation media, pH control chemicals, cooling, organic compound destruction, emissions treatment liquids, and slurry handling throughout the shredding and downstream separation process. The plumbing is modular and industrial grade to support continuous operation while minimizing fire risk, fugitive emissions, and maintenance downtime. Only a few piping installations need to be made when the system is installed at its final destination. With the modular plumbing, the piping runs are already cut to length and only need to be connected into the equipment. The final plumbing connections to transition the system from its shipping configuration to its operating configuration are listed below.
1) 316 stainless steel connections on the bottom of both 1000 gallon PVC tanks into the pump cabinet for water/slurry exiting the tanks
2) 316 stainless steel connections into the top of both 1000 gallon PVC from the pump cabinet for water/slurry into the tanks
3) 316 stainless steel connection from venturi wet scrubber into the vibratory pan sump tank
4) 316 stainless steel connections from vibratory pan sump tank into the circular screen
5) 316 stainless steel connection from circular screen into the black mass sump tank
6) 316 stainless steel connection from black mass sump tank into the pump cabinet
7) CPVC tubing glued into final location for both acid and alkaline chemical additives into the water tank and emissions treatment system

Similarly, only a few electrical installations and connections need to be made when the system is installed at its final destination. As with the piping installations to complete the plumbing, these electrical runs are cut to length, labeled, have labeled junction boxes close by, and have automation instruments pre-installed. The final electrical connections to transition the system from its shipping configuration to its operating configuration are listed below.
1) Instruments: Two 1000 gallon PVC tanks: level sensor, high level switch and low-level switch. The junction box is located on the pump cabinet.
2) Instruments and Motor: Cavitation System electrolyzer and high speed pump motor. Both the instrument and motor junction boxes are located on the pump cabinet.
3) Motor: Circular screen motor. The motor junction box is located between the filter press and dewatering auger for metals.
4) Instruments and Motor: Black mass sump tank pump motor, stirring auger motor, and level sensor 216 needs to be wired. The motor and instrument junction boxes are located between the filter press and dewatering auger for metals.
5) Motors: Both the dewatering auger for plastics and dewatering auger for metals need to be physically installed when the apparatus arrives to the customer site and both have a motor that need to be connected to the motor junction box which is located between the filter press and dewatering auger for metals.
6) Motors: The Rotating Magnet has three (3) motors that need to be connected to the motor junction box is located between the filter press and dewatering auger for metals.

By enabling safe, immediate shredding of intact battery-containing devices without prior battery removal, the apparatus of the present invention significantly reduces labor requirements, improves processing throughput, and minimizes the risk of fire, explosion, and toxic emissions. The system maintains a closed-loop liquid and emissions management process while safely and efficiently separating shredded e-scrap into recoverable outputs, including black mass slurry, plastic pieces, ferrous metals, and non-ferrous metals. The system provides recycling facilities with a system that allows for safe, economical shredding and recycling of the materials in the e-scrap. The modular and compact design of the system permits preassembled units to be transported in standard shipping containers, enabling mobile deployment to disaster response zones, remote industrial sites, contract recycling operations, and facilities with limited floor space. The system is applicable to a wide range of industrial, municipal, and commercial recycling environments where end-of-life electronics containing embedded lithium-ion batteries must be processed safely and efficiently. It will be appreciated that the electronics may also include other types of rechargeable batteries, such as nickel-metal hydride (NiMH) batteries, as well as non-rechargeable alkaline batteries, and the system allows for treating and recovering materials from these batteries. Municipal waste handling sites, transfer stations, and household hazardous waste programs can deploy the system to mitigate fire hazards arising from lithium-ion batteries frequently found in consumer electronics discarded in mixed-waste bins.

The embodiments were chosen and described to best explain the principles of the invention and its practical application to persons who are skilled in the art. As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. An apparatus for shredding and recycling a plurality of electronic devices containing lithium batteries, comprising:
an elongated platform comprising a top surface, a bottom surface, a pair of longitudinal sides defining a length of the elongated platform, and a pair of
transverse sides extending between the longitudinal sides and defining a width of the elongated platform, wherein the pair of longitudinal sides and the pair of transverse sides define a perimeter of the elongated platform;
a deluge shredder assembly connected to and positioned above the elongated platform within the perimeter, wherein the deluge shredder assembly
receives through an opening the electronic devices and comminutes the electronic devices with a flow of water into solid fragments and a black mass slurry comprised of black mass material and particulates mixed with the water;
a vibratory pan assembly positioned below the deluge shredder assembly, wherein the vibratory pan assembly is comprised of a perforated plate and a ledge at a distal end and a collection tray below the perforated plate, wherein the vibratory pan assembly is connected to and positioned above the elongated platform within the perimeter, wherein the vibratory pan assembly receives the solid fragments and the black mass slurry on the perforated plate, wherein the black mass slurry passes through the perforated plate into the collection tray, and wherein the solid fragments are driven on the perforated plate toward the ledge;
a black mass tank, wherein the black mass material flows with the water into the black mass tank;
a first pump operatively connected to the black mass tank;
a means for separating the black mass material from the water, wherein the separating means is connected to and positioned above the elongated platform
within the perimeter, and wherein the first pump pushes the black mass material and water from the black mass tank to the separating means;
a sink-float tank mounted directly to and positioned within the perimeter of the elongated platform adjacent to the vibratory pan assembly, wherein the
ledge at the distal end of the vibratory pan assembly extends into an interior of the sink-float tank, wherein the solid fragments fall from the distal end of the vibratory pan assembly into the sink-float tank, wherein the sink-float tank contains saltwater with a specific gravity within a threshold range allowing lighter plastic pieces in the solid fragments to float at a waterline for the saltwater and heavier pieces in the solid fragments to sink to a bottom of the sink-float tank, and wherein the sink-float tank comprises an upper auger for moving the plastic pieces to an upper discharge end and a lower auger for moving the heavier pieces to a lower discharge end;
an upper dewatering auger assembly in fluid communication with the sink-float tank adjacent to the upper discharge end, wherein the upper dewatering
auger assembly receives in a first lower end the lighter plastic pieces and a nappe of saltwater at the waterline, and wherein the upper dewatering auger assembly expels the plastic pieces at a first upper end and drains the nappe of saltwater into the first lower end; and
a lower dewatering auger assembly in fluid communication with the sink-float tank at the lower discharge end, wherein the lower dewatering auger
assembly receives in a second lower end the heavier pieces and saltwater from the bottom of the sink-float tank, and wherein the lower dewatering auger assembly expels the heavier pieces at a second upper end and drains the saltwater into the second lower end.

2. The apparatus of claim 1, wherein the upper dewatering auger assembly and the lower dewatering auger assembly each has a stowed arrangement within the perimeter of the elongated platform for a shipping configuration of the apparatus, wherein the upper dewatering auger assembly and the lower dewatering auger assembly each has an engaged arrangement for an operating configuration of the apparatus, wherein the first lower end and the second lower end are disconnected from the sink-float tank in the stowed arrangement, and wherein the first upper end and the second upper end extend beyond the perimeter in the engaged arrangement.

3. The apparatus of claim 2, further comprising a magnetic roller discharge assembly positioned below the second upper end of the lower dewatering auger outside of the perimeter of the elongated platform in the operating configuration of the apparatus, wherein the magnetic roller discharge assembly is comprised of a vibrating plate, an overhead magnetic drum, a first chute, and a second chute, wherein the heavier pieces fall onto the vibrating plate from the second upper end, wherein non-magnetic materials in the heavier pieces fall into the first chute, wherein magnetic materials in the heavier pieces are pulled up to the magnetic drum and are dropped into the second chute, wherein the magnetic roller discharge assembly is positioned within the perimeter of the elongated platform in the shipping configuration of the apparatus.

4. The apparatus of claim 1, further comprising:
a water tank containing a reservoir of water;
a second pump, wherein the flow of water in the deluge shredder assembly is pumped from the reservoir of water in the water tank by the second pump,
a cavitation system in fluid communication with the water tank for closed loop recirculation of the water between the cavitation system and the water tank;
a heat exchanger in fluid communication with the water tank for closed loop recirculation of the water between the heat exchanger and the water tank;
a vibratory pan sump tank positioned below the collection tray of the vibratory pan assembly, wherein the vibratory pan sump tank is mounted directly to and
positioned within the perimeter of the elongated platform in a shipping configuration and in an operating configuration of the apparatus, wherein the black mass slurry drains from the collection tray into the vibratory pan sump tank;
a black mass sump tank in upstream communication with the black mass tank; and
a circular vibrating screen assembly in downstream communication with the vibratory pan sump tank and in upstream communication with the sink-float tank
and the black mass sump tank, wherein the circular vibrating screen assembly is positioned within the perimeter of the elongated platform in the shipping configuration of the apparatus, wherein the black mass slurry is pumped by a third pump from the vibratory pan sump tank to an inlet for the circular vibrating screen assembly, wherein the black mass material and water pass through a screen mesh in the circular vibrating screen assembly and drain into the black mass sump tank and are pumped with a fourth pump into the black mass tank, and wherein the particulates vibrate around the screen mesh to an outlet port in the circular vibrating screen assembly and fall into the sink-float tank.

5. The apparatus of claim 4, further comprising an electrical cabinet with a computer controller, wherein the electrical cabinet is mounted directly to the elongated platform and positioned within the perimeter in the shipping configuration and in the operating configuration of the apparatus, wherein the water tank is further comprised of a first temperature sensor, a first water level sensor, and a first water level switch in operative communication with the computer controller, wherein the first temperature sensor produces a first temperature reading of the water in the water tank, wherein the computer controller directs the water in the water tank through the heat exchanger if the first temperature reading exceeds a first temperature threshold, and wherein the computer controller causes the apparatus to stop operating if the first temperature reading exceeds a second temperature threshold greater than the first temperature threshold.

6. The apparatus of claim 4, further comprising a centrate tank in downstream communication with the separating means and in upstream communication with the water tank, wherein the water separated from the black mass material in the separating means flows into the centrate tank and is pumped back into the water tank by a fifth pump, and wherein the separating means is selected from the group of separator consisting of a filter press, a centrifuge filter, and a hydrocyclone.

7. The apparatus of claim 4, further comprising:
a plurality of exhaust ducts connected at an upstream end to the deluge shredder assembly and the sink-float tank, wherein the exhaust ducts are positioned
within the perimeter of the elongated platform in the shipping configuration and in the operating configuration of the apparatus;
a wet scrubber connected to and positioned above the elongated platform within the perimeter in the shipping configuration and in the operating configuration
of the apparatus, wherein a downstream end of the exhaust ducts is connected to the wet scrubber, wherein a drain tube connects the wet scrubber with the vibratory pan sump tank, wherein the wet scrubber removes entrained solids and condensate from an airflow received through the exhaust ducts, wherein the entrained solids and condensate flow through the drain tube from the wet scrubber to the vibratory pan sump tank;
a packed tower scrubber connected to and positioned above the elongated platform within the perimeter in the shipping configuration and in the operati
ng configuration of the apparatus, wherein the airflow exiting the wet scrubber enters the packed tower scrubber;
an exhaust fan connected to and positioned above the elongated platform within the perimeter in the shipping configuration and in the operating configuration
of the apparatus, wherein the exhaust fan is downstream from and draws the airflow through the wet scrubber and the packed tower scrubber; and
a high-efficiency particulate air filter connected to and positioned above the elongated platform within the perimeter in the shipping configuration and in the
operating configuration of the apparatus, wherein the high-efficiency particulate air filter is operatively connected to the packed tower scrubber and the exhaust fan and removes ultrafine particulates from the airflow.

8. The apparatus of claim 1, further comprising:
an infeed hopper assembly for receiving the electronic devices, wherein the infeed hopper assembly is connected to and positioned above the elongated
platform within the perimeter in a shipping configuration and an operating configuration of the apparatus and comprises an open topside, a tapered lower section, a door positioned in an aperture proximate to a bottom panel of the tapered lower section, and an actuator operatively connected to the door, wherein the actuator adjusts door between a first position within the aperture and a second position within the aperture, wherein the first position opens a first portion of the aperture to allow a first flow rate of the electronic devices out of the infeed hopper, wherein the second position opens a second portion of the aperture to allow a second flow rate of the electronic devices out of the infeed hopper, and wherein the second portion of the aperture and the second flow rate are greater than first portion of the aperture and the first flow rate, respectively;
a shaker table frame comprising a bottom section and a top section, wherein the bottom section is mounted directly to the elongated platform adjacent to the
sink-float tank and within the perimeter in the shipping configuration and in the operating configuration of the apparatus, and wherein the deluge shredder assembly and the vibratory pan assembly are mounted to the top section in the shipping configuration and in the operating configuration of the apparatus; and
an inclined conveyor extending from a lower tail to an upper head within the perimeter of the elongated platform, wherein the lower tail is positioned below
the aperture in the infeed hopper assembly and is mounted directly to the elongated platform in the shipping configuration and in the operating configuration of the apparatus, and wherein the upper head extends to the deluge shredder assembly and is mounted to the top section of the shaker table frame.

9. The apparatus of claim 8, wherein the infeed hopper assembly is further comprised of a lateral conveyor mounted directly to the elongated platform and positioned within the perimeter below the aperture of the infeed hopper and above the lower tail of the inclined conveyor in the shipping configuration and in the operating configuration of the apparatus, wherein the lateral conveyor receives the flow of the electronic devices from the infeed hopper at a lateral tail and discharges the electronic devices from a lateral head onto the lower tail of the inclined conveyor.

10. The apparatus of claim 8, wherein the deluge shredder assembly is further comprised of a deluge hopper, a wet shredder, a spray bar, and multiple nozzles, wherein the deluge hopper is comprised of a plurality of sidewalls, an opening in one of the sidewalls, a curtain in the opening, a closed top, and an open bottom, wherein the spray bar is positioned proximate to the closed top of the deluge hopper, wherein the nozzles are fluidly connected to the spray bar and are aimed downward toward the open bottom, wherein the wet shredder is comprised of a cutting chamber above a screen, wherein the wet shredder is attached to the sidewalls of the deluge hopper spaced directly below the open bottom, wherein the nozzles spray the continuous flow of water onto the electronic devices upon entering into the deluge hopper through the opening and while the electronic devices fall through the open bottom in the deluge hopper and are comminuted in the cutting chamber into the solid fragments and the black mass slurry that pass through the screen to the vibratory pan assembly, wherein the vibratory pan assembly is further comprised of a vibratory motor, a plurality of springs, and a plurality of ports, wherein the springs connect the vibratory pan assembly to the shaker table, and wherein the ports are attached to the collection tray and channel the black mass slurry.

11. An apparatus for shredding and recycling a plurality of electronic devices containing lithium batteries, comprising:
an elongated platform comprising a top surface, a bottom surface, a pair of longitudinal sides defining a length of the elongated platform, and a pair of
transverse sides extending between the longitudinal sides and defining a width of the elongated platform, wherein the pair of longitudinal sides and the pair of transverse sides define a perimeter of the elongated platform;
a deluge shredder assembly connected to and positioned above the elongated platform within the perimeter in a shipping configuration and in an operating
configuration of the apparatus, wherein the deluge shredder assembly receives through an opening the electronic devices and comminutes the electronic devices with a flow of water into solid fragments and a black mass slurry comprised of black mass material and particulates mixed with the water;
a vibratory pan assembly positioned below the deluge shredder assembly, wherein the vibratory pan assembly is comprised of a perforated plate and a
ledge at a distal end and a collection tray below the perforated plate, wherein the vibratory pan assembly is connected to and positioned above the elongated platform within the perimeter in the shipping configuration and in the operating configuration of the apparatus, wherein the vibratory pan assembly receives the solid fragments and the black mass slurry on the perforated plate, wherein the black mass slurry passes through the perforated plate into the collection tray, and wherein the solid fragments are driven on the perforated plate toward the ledge;
a black mass tank, wherein the black mass material settles at a bottom of the black mass tank;
a first pump operatively connected to the bottom of the black mass tank;
a means for separating the black mass material from the water, wherein the separating means is connected to and positioned above the elongated platform
within the perimeter in the shipping configuration and in the operating configuration of the apparatus, and wherein the first pump pushes the black mass material and water from the black mass tank to the separating means;
a sink-float tank mounted directly to and positioned within the perimeter of the elongated platform adjacent to the vibratory pan assembly in the shipping
configuration and in the operating configuration of the apparatus, wherein the ledge at the distal end of the vibratory pan assembly extends into an interior of the sink-float tank, wherein the solid fragments fall from the distal end of the vibratory pan assembly into the sink-float tank, wherein the sink-float tank contains saltwater with a specific gravity within a threshold range allowing lighter plastic pieces in the solid fragments to float at a waterline for the saltwater and heavier pieces in the solid fragments to sink to a bottom of the sink-float tank, and wherein the sink-float tank comprises an upper auger for moving the plastic pieces to an upper discharge end and a lower auger for moving the heavier pieces to a lower discharge end;
an upper dewatering auger assembly in fluid communication with the sink-float tank adjacent to the upper discharge end in the operating configuration of
the apparatus, wherein the upper dewatering auger assembly receives in a first lower end the lighter plastic pieces and a nappe of saltwater at the waterline and expels the plastic pieces at a first upper end and drains the nappe of saltwater into the first lower end in the operating configuration, wherein the first upper end is outside the perimeter of the elongated platform in the operating configuration, and wherein a first stowed arrangement of the upper dewatering auger assembly is entirely within the perimeter of the elongated platform for the shipping configuration of the apparatus; and
a lower dewatering auger assembly in fluid communication with the sink-float tank at the lower discharge end, wherein the lower dewatering auger
assembly receives in a second lower end the heavier pieces and saltwater from the bottom of the sink-float tank and expels the heavier pieces at a second upper end and drains the saltwater into the second lower end in the operating configuration, wherein the second upper end is outside the perimeter of the elongated platform in the operating configuration, and wherein a second stowed arrangement of the upper dewatering auger assembly is entirely within the perimeter of the elongated platform for the shipping configuration of the apparatus.

12. The apparatus of claim 11, further comprising:
a vibratory pan sump tank positioned below the collection tray of the vibratory pan assembly, wherein the vibratory pan sump tank is mounted directly to and
positioned within the perimeter of the elongated platform in the shipping configuration and in the operating configuration of the apparatus, wherein the black mass slurry drains from the collection tray into the vibratory pan sump tank;
a black mass sump tank in upstream communication with the black mass tank; and
a circular vibrating screen assembly in downstream communication with the vibratory pan sump tank and in upstream communication with the sink-float tank
and the black mass sump tank, wherein the circular vibrating screen assembly is positioned within the perimeter of the elongated platform in the shipping configuration of the apparatus, wherein the black mass slurry is pumped by a second pump from the vibratory pan sump tank to an inlet for the circular vibrating screen assembly, wherein the black mass material and water pass through a screen mesh in the circular vibrating screen assembly and drain into the black mass sump tank and are pumped with a third pump into the black mass tank, and wherein the particulates vibrate around the screen mesh to an outlet port in the circular vibrating screen assembly and fall into the sink-float tank.

13. The apparatus of claim 12, further comprising:
a plurality of exhaust ducts connected at an upstream end to the deluge shredder assembly and the sink-float tank, wherein the exhaust ducts are positioned
within the perimeter of the elongated platform in the shipping configuration and in the operating configuration of the apparatus;
a wet scrubber connected to and positioned above the elongated platform within the perimeter in the shipping configuration and in the operating configuration
of the apparatus, wherein a downstream end of the exhaust ducts is connected to the wet scrubber, wherein a drain tube connects the wet scrubber with the vibratory pan sump tank, wherein the wet scrubber removes entrained solids and condensate from an airflow received through the exhaust ducts, wherein the entrained solids and condensate flow through the drain tube from the wet scrubber to the vibratory pan sump tank;
a packed tower scrubber connected to and positioned above the elongated platform within the perimeter in the shipping configuration and in the operating
configuration of the apparatus, wherein the airflow exiting the wet scrubber enters the packed tower scrubber;
an exhaust fan connected to and positioned above the elongated platform within the perimeter in the shipping configuration and in the operating configuration
of the apparatus, wherein the exhaust fan is downstream from and draws the airflow through the wet scrubber and the packed tower scrubber; and
a high-efficiency particulate air filter connected to and positioned above the elongated platform within the perimeter in the shipping configuration and in the
operating configuration of the apparatus, wherein the high-efficiency particulate air filter is operatively connected to the packed tower scrubber and the exhaust fan and removes ultrafine particulates from the airflow.

14. The apparatus of claim 11, further comprising:
a water tank containing a reservoir of water, wherein the flow of water to the deluge shredder assembly is pumped from the reservoir of water in the water
tank; and
a cavitation system in fluid communication with the water tank for closed loop recirculation of the water between the cavitation system and the water tank.

15. The apparatus of claim 14, further comprising:
an infeed hopper assembly for receiving the electronic devices, wherein the infeed hopper assembly is connected to and positioned above the elongated platform within the perimeter in a shipping configuration and an operating configuration of the apparatus and comprises an open topside, a tapered lower section, a door positioned in an aperture proximate to a bottom panel of the tapered lower section, and an actuator operatively connected to the door, wherein the actuator adjusts door between a first position within the aperture and a second position within the aperture, wherein the first position opens a first portion of the aperture to allow a first flow rate of the electronic devices out of the infeed hopper, wherein the second position opens a second portion of the aperture to allow a second flow rate of the electronic devices out of the infeed hopper, and wherein the second portion of the aperture and the second flow rate are greater than first portion of the aperture and the first flow rate, respectively;
a shaker table frame comprising a bottom section and a top section, wherein the bottom section is mounted directly to the elongated platform adjacent to
the sink-float tank and within the perimeter in the shipping configuration and in the operating configuration of the apparatus, and wherein the deluge shredder assembly and the vibratory pan assembly are mounted to the top section in the shipping configuration and in the operating configuration of the apparatus;
an inclined conveyor extending from a lower tail to an upper head within the perimeter of the elongated platform, wherein the lower tail is positioned
below the aperture in the infeed hopper assembly and is mounted directly to the elongated platform in the shipping configuration and in the operating configuration of the apparatus, and wherein the upper head extends to the deluge shredder assembly and is mounted to the top section of the shaker table frame;
a centrate tank in downstream communication with the separating means and in upstream communication with the water tank, wherein the water
separated from the black mass material in the separating means flows into the centrate tank and is pumped back into the water tank;
a heat exchanger in fluid communication with the water tank for closed loop recirculation of the water between the heat exchanger and the water tank; and
an electrical cabinet with a computer controller, wherein the electrical cabinet is mounted directly to the elongated platform and positioned within the perimeter in the shipping configuration and in the operating configuration of the apparatus, wherein the water tank is further comprised of a first temperature sensor, a first water level sensor, and a first water level switch in operative communication with the computer controller, wherein the first temperature sensor produces a first temperature reading of the water in the water tank, wherein the computer controller directs the water in the water tank through the heat exchanger if the first temperature reading exceeds a first temperature threshold, and wherein the computer controller causes the apparatus to stop operating if the first temperature reading exceeds a second temperature threshold greater than the first temperature threshold.

16. An apparatus for shredding and recycling a plurality of electronic devices containing lithium batteries, comprising:
an elongated platform comprising a top surface, a bottom surface, a pair of longitudinal sides defining a length of the elongated platform, and a pair of
transverse sides extending between the longitudinal sides and defining a width of the elongated platform, wherein the pair of longitudinal sides and the pair of transverse sides define a perimeter of the elongated platform;
a deluge shredder assembly connected to and positioned above the elongated platform within the perimeter, wherein the deluge shredder assembly
receives through an opening the electronic devices and comminutes the electronic devices with a flow of water into solid fragments and a black mass slurry comprised of black mass material and particulates mixed with the water;
a vibratory pan assembly positioned below the deluge shredder assembly, wherein the vibratory pan assembly is comprised of a perforated plate and a
ledge at a distal end and a collection tray below the perforated plate, wherein the vibratory pan assembly is connected to and positioned above the elongated platform within the perimeter, wherein the vibratory pan assembly receives the solid fragments and the black mass slurry on the perforated plate, wherein the black mass slurry passes through the perforated plate into the collection tray, and wherein the solid fragments are driven on the perforated plate toward the ledge;
a black mass tank, wherein the black mass material flows with the water into the black mass tank;
a first pump operatively connected to the black mass tank;
a means for separating the black mass material from the water, wherein the separating means is connected to and positioned above the elongated platform
within the perimeter, and wherein the first pump pushes the black mass material and water from the black mass tank to the separating means;
a sink-float tank mounted directly to and positioned within the perimeter of the elongated platform adjacent to the vibratory pan assembly, wherein the
ledge at the distal end of the vibratory pan assembly extends into an interior of the sink-float tank, wherein the solid fragments fall from the distal end of the vibratory pan assembly into the sink-float tank, wherein the sink-float tank contains saltwater with a specific gravity within a threshold range allowing lighter plastic pieces in the solid fragments to float at a waterline for the saltwater and heavier pieces in the solid fragments to sink to a bottom of the sink-float tank, and wherein the sink-float tank comprises an upper auger for moving the plastic pieces to an upper discharge end and a lower auger for moving the heavier pieces to a lower discharge end;
an upper dewatering auger assembly in fluid communication with the sink-float tank adjacent to the upper discharge end, wherein the upper dewatering
auger assembly receives in a first lower end the lighter plastic pieces and a nappe of saltwater at the waterline, and wherein the upper dewatering auger assembly expels the plastic pieces at a first upper end and drains the nappe of saltwater into the first lower end;
a lower dewatering auger assembly in fluid communication with the sink-float tank at the lower discharge end, wherein the lower dewatering auger
assembly receives in a second lower end the heavier pieces and saltwater from the bottom of the sink-float tank, and wherein the lower dewatering auger assembly expels the heavier pieces at a second upper end and drains the saltwater into the second lower end;
a water tank containing a reservoir of water;
a second pump, wherein the flow of water in the deluge shredder assembly is pumped from the reservoir of water in the water tank by the second pump,
a cavitation system in fluid communication with the water tank for closed loop recirculation of the water between the cavitation system and the water tank;
a vibratory pan sump tank positioned below the collection tray of the vibratory pan assembly, wherein the vibratory pan sump tank is mounted directly to
and positioned within the perimeter of the elongated platform, wherein the black mass slurry drains from the collection tray into the vibratory pan sump tank;
a black mass sump tank in upstream communication with the black mass tank;
a circular vibrating screen assembly in downstream communication with the vibratory pan sump tank and in upstream communication with the sink-float
tank and the black mass sump tank, wherein the black mass slurry is pumped by a third pump from the vibratory pan sump tank to an inlet for the circular vibrating screen assembly, wherein the black mass material and water pass through a screen mesh in the circular vibrating screen assembly and drain into the black mass sump tank and are pumped with a fourth pump into the black mass tank, and wherein the particulates vibrate around the screen mesh to an outlet port in the circular vibrating screen assembly and fall into the sink-float tank; and
a centrate tank in downstream communication with the separating means and in upstream communication with the water tank, wherein the water separated from the black mass material in the separating means flows into the centrate tank and is pumped back into the water tank by a fifth pump.

17. The apparatus of claim 16, wherein the cavitation system is comprised of dual cavitation cells and an electrolysis cell.

18. The apparatus of claim 16, further comprising:
a heat exchanger in fluid communication with the water tank for closed loop recirculation of the water between the heat exchanger and the water tank; and
an electrical cabinet with a computer controller, wherein the electrical cabinet is mounted directly to the elongated platform and positioned within the
perimeter, wherein the water tank is further comprised of a first temperature sensor, a first water level sensor, and a first water level switch in operative communication with the computer controller, wherein the first temperature sensor produces a first temperature reading of the water in the water tank, wherein the computer controller directs the water in the water tank through the heat exchanger if the first temperature reading exceeds a first temperature threshold, and wherein the computer controller causes the apparatus to stop operating if the first temperature reading exceeds a second temperature threshold greater than the first temperature threshold.

19. The apparatus of claim 18, further comprising:
an infeed hopper assembly for receiving the electronic devices, wherein the infeed hopper assembly is connected to and positioned above the elongated
platform within the perimeter and comprises an open topside and an aperture in a lower section, and wherein the aperture restricts a flow rate of the electronic devices out of the infeed hopper assembly;
a shaker table frame comprising a bottom section and a top section, wherein the bottom section is mounted directly to the elongated platform within the
perimeter, and wherein the deluge shredder assembly and the vibratory pan assembly are mounted to the top section;
an inclined conveyor extending from a lower tail to an upper head within the perimeter of the elongated platform, wherein the lower tail is positioned below
the aperture in the infeed hopper assembly and is mounted directly to the elongated platform, and wherein the upper head extends to the opening in the deluge shredder assembly and is mounted to the top section of the shaker table frame;
a plurality of exhaust ducts connected at an upstream end to the deluge shredder assembly and the sink-float tank;
a wet scrubber connected to and positioned above the elongated platform within the perimeter, wherein a downstream end of the exhaust ducts is connected
to the wet scrubber, wherein a drain tube connects the wet scrubber with the black mass tank, wherein the wet scrubber removes entrained solids and condensate from an airflow received through the exhaust ducts, wherein the entrained solids and condensate flow through the drain tube from the wet scrubber to the black mass tank;
a packed tower scrubber connected to and positioned above the elongated platform within the perimeter, wherein the airflow exiting the wet scrubber enters
the packed tower scrubber;
an exhaust fan connected to and positioned above the elongated platform within the perimeter downstream of the wet scrubber and the packed tower
scrubber, wherein the exhaust fan draws the airflow through the wet scrubber and the packed tower scrubber; and
a high-efficiency particulate air filter connected to and positioned above the elongated platform within the perimeter, wherein the high-efficiency particulate air
filter is operatively connected to the packed tower scrubber and the exhaust fan and removes ultrafine particulates from the airflow.

20. The apparatus of claim 19, wherein the infeed hopper assembly, the inclined conveyor, the shaker table, the deluge shredder assembly, the vibratory pan assembly, the vibratory pan sump tank, the sink-float tank, the separating means, the wet scrubber, the packed tower scrubber, the exhaust fan, the high-efficiency particulate air filter, and the electrical cabinet are connected to the elongated platform in a shipping configuration and in an operating configuration of the apparatus, wherein the upper dewatering auger assembly and the lower dewatering auger assembly each has a stowed arrangement within the perimeter of the elongated platform for the shipping configuration of the apparatus, wherein the upper dewatering auger assembly and the lower dewatering auger assembly each has an engaged arrangement for the operating configuration of the apparatus, wherein the first lower end and the second lower end are disconnected from the sink-float tank in the stowed arrangement and connected to the sink-float tank in the engaged arrangement, and wherein the first upper end and the second upper end extend beyond the perimeter in the engaged arrangement.
